(19) United States
(12) Patent Application Publication
(10) Pub. No.: US 2019/0010735 A1
(43) Pub. Date: Jan. 10, 2019

(54) DOOR LOCK DEVICE FOR VEHICLES

(71) Applicant: KABUSHIKI KAISHA TOKAI RIKA DENKI SEISAKUSHO, Aichi (JP)

(72) Inventor: Keishi KANEMATSU, Aichi (JP)

(73) Assignee: KABUSHIKI KAISHA TOKAI RIKA DENKI SEISAKUSHO, Aichi (JP)

(21) Appl. No.: 16/067,697

(22) PCT Filed: Jan. 5, 2017
(86) PCT No.: PCT/JP2017/000122

§ 371 Date: Jul. 2, 2018

(30) Foreign Application Priority Data
Jan. 7, 2016 (JP) 2016-001833

(51) Int. Cl. E05B 77/24; E05B 81/76; E05B 81/04; E05B 81/16

(52) U.S. Cl. CPC E05B 77/24; E05B 81/16; E05B 81/04; E05B 81/76

(57) ABSTRACT

A door lock device for vehicles is provided with sensors for detecting whether or not a door of a vehicle can be opened safely; a door lock drive unit for switching the door between a lock state and an unlock state; and a control unit for controlling the door lock drive unit. When determining on the basis of detection signals from the sensors that the safety of opening the door cannot be ensured, the control unit maintains the door in the lock state through the door lock drive unit, and when the number of operations of the inside door handle of the door is more than or equal to a predetermined value, the control unit forcibly switches the door to the unlock state through the door lock drive unit independent of the detection signals from the sensors.

### TECHNICAL FIELD

The present invention relates to a vehicle door lock device.

### BACKGROUND ART

Patent document 1 discloses a vehicle door opening/closing control device. The door opening/closing control device locks a vehicle door to prohibit opening of the door when detecting an approaching object that is approaching the vehicle and unlocks the vehicle door after the approaching object passes by.

Patent document 2 discloses a control device that locks a door of a vehicle when detecting another vehicle approaching the vehicle from the rear.

Patent document 3 discloses a vehicle rear monitoring device. When an occupant attempts to open a door in a state in which another vehicle is approaching the vehicle from the rear, the vehicle rear monitoring device notifies the occupant of the other approaching vehicle.

Patent document 4 discloses an approaching object detection system that keeps a door of a vehicle locked when detecting an object approaching the vehicle. The approaching object detection system is configured to unlock the door when an occupant pushes an unlock button dedicated for an unlocking device.

### PRIOR ART DOCUMENT

### Patent Documents

### Patent Document 1: Japanese Laid-Open Patent Publication No. 2002-225560

Patent Document 2: Japanese Laid-Open Patent Publication No. 2012-116348

Patent Document 3: Japanese Laid-Open Patent Publication No. 2009-78674

Patent Document 4: Japanese Laid-Open Patent Publication No. 2011-111069

### SUMMARY OF THE INVENTION

In patent document 1, the occupant is not allowed to open the door from when detecting an approaching object to when the approaching object passes by. When the speed of the approaching object is slow, it will take time until the occupant can open the door and get out of the vehicle.

In patent document 2, the occupant is not allowed to open the door from when detecting the approach of a vehicle from the rear to when the vehicle passes by.

The device of patent document 3 notifies the occupant of the approach of another vehicle from the rear. However, the device does not lock the door. Thus, sufficient safety may not be ensured when the occupant gets out of the vehicle.

In patent document 4, even if a door lock state is being maintained, the occupant can push the unlock button dedicated for the unlocking device to unlock the door. Thus, sufficient safety may not be ensured when the occupant gets out of the vehicle.

Accordingly, it is an object of the present invention to provide a vehicle door lock device that ensures safety when an occupant gets out of a vehicle while allowing the occupant to get out of the vehicle smoothly and quickly.

A vehicle door lock device includes one or more sensors configured to detect whether or not a door of a vehicle can be safely opened, a door lock drive unit configured to switch the door between a lock state and an unlock state, and a controller configured to receive a detection signal of the one or more sensors and control the door lock drive unit. The controller includes one or more processors configured to keep the door in the lock state with the door lock drive unit when determining from the detection signal of the one or more sensors that the door cannot be safely opened. The one or more processors are configured to count a number of times an inside door handle of the door has been operated. The one or more processors are configured to forcibly switch the door to the unlock state with the door lock drive unit regardless of the detection signal from the one or more sensors when a count value of the number of times the inside door handle has been operated is greater than or equal to a predetermined value that is an integer greater than or equal to two.

When a manual action of an occupant causes the count value to be greater than or equal to the predetermined value, the occupant is likely to have checked whether it is safe outside the vehicle. When the count value is greater than or equal to the predetermined value, regardless of the detection signal, when the one or more processors forcibly switch the door to an unlock state with the door lock drive unit, the safety when the occupant gets out of the vehicle is ensured while allowing the occupant to get out of the vehicle smoothly and quickly.

It is preferred that the controller include an electrostatic capacitance detection circuit, the electrostatic capacitance detection circuit is connected to an electrostatic capacitance electrode, electrostatic capacitance of which increases when the inside door handle is operated, to detect electrostatic capacitance of the electrostatic capacitance electrode. Further, it is preferred that the one or more processors is configured to obtain a number of times the electrostatic capacitance detected by the electrostatic capacitance detection circuit increases as the number of times the inside door handle has been operated.

This configuration allows the controller to control unlocking of the door in accordance with the number of times the inside door handle has been operated.

It is preferred that the one or more sensors include a movable body sensor configured to detect a movable body approaching the vehicle and a proximate object sensor configured to detect an obstacle proximate to the vehicle.

This configuration allows the controller to determine whether or not the door of the vehicle can be safely opened in accordance with the detection signals of the moving body sensor and the proximate object sensor.

It is preferred that the one or more processors is configured to forcibly switch the door lock drive unit to the unlock state when the count value is two or greater.

With this configuration, when the inside door handle is operated twice or more, the door is forcibly switched to the unlock state with the door lock drive unit.

It is preferred that the one or more sensors include a vehicle speed sensor and a buckle switch sensor. Further, it is preferred that the one or more processors is configured to maintain a door lock state regardless of the count value when the vehicle is traveling, which is detected by the vehicle speed sensor, and when a seat belt is fastened, which is detected by the buckle switch sensor.

This configuration prohibits opening of the door when the vehicle is traveling and when the seat belt is fastened.

The vehicle door lock device according to several aspects of the present invention ensures safety when the occupant gets out of the vehicle while allowing the occupant to get out of the vehicle smoothly and quickly. Other aspects and advantages of the present invention will become apparent from the following description, taken in conjunction with the accompanying drawings, illustrating by way of example the principles of the invention.

### BRIEF DESCRIPTION OF THE DRAWINGS

FIG. 1 is a block diagram of a vehicle door lock device.

FIG. 2 is a flowchart illustrating the operation of the vehicle door lock device.

### EMBODIMENTS OF THE INVENTION

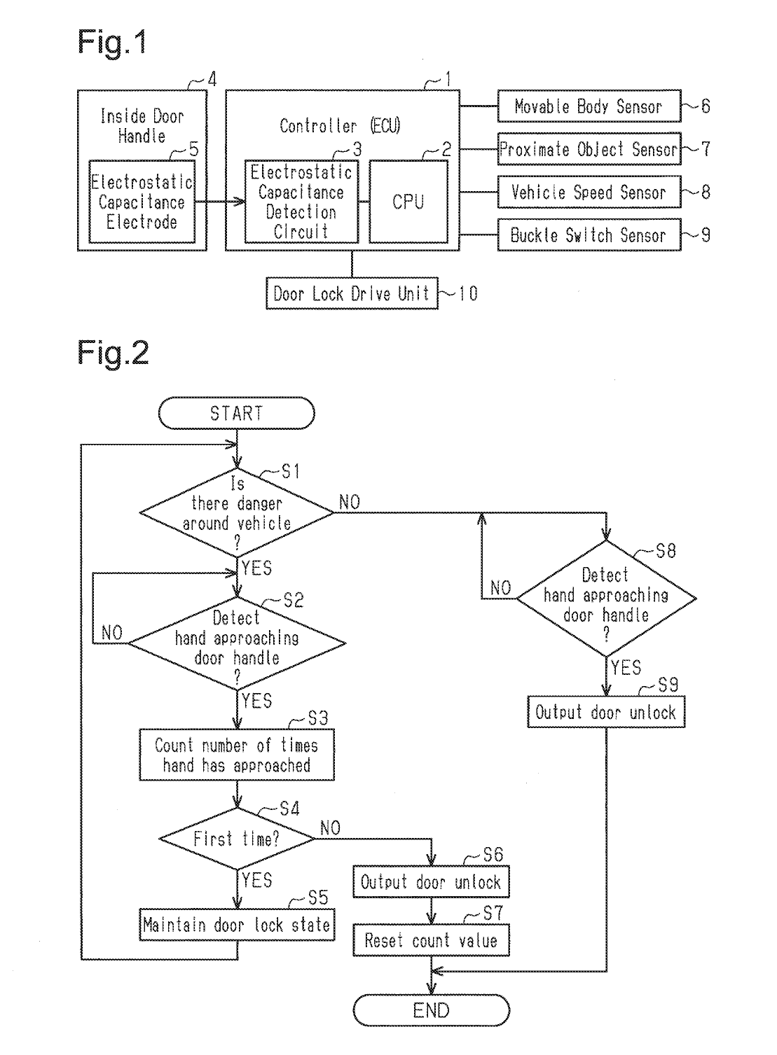

One embodiment of a vehicle door lock device will now be described. In FIG. 1., a controller 1 controls locking and unlocking of a vehicle door. The controller 1 is generally an ECU. The controller 1 includes a CPU 2 and an electrostatic capacitance detection circuit 3 that outputs, to the CPU 2, a detection signal of the detected change in the electrostatic capacitance.

The electrostatic capacitance detection circuit 3 is connected to an electrostatic capacitance electrode 5 arranged in an inside door handle 4. The electrostatic capacitance detection circuit 3 outputs a detection signal to the CPU 2 when an occupant of the vehicle touches the inside door handle 4 and the electrostatic capacitance of the electrostatic capacitance electrode 5 exceeds a predetermined threshold value.

Although obvious to one skilled in the art, the inside door handle 4 refers to a handle operated with a hand or a finger when the occupant opens the door from the inside of the passenger compartment, and the inside door handle 4 is generally a lever-type handle. The inside door handle 4 may differ from a push-button or a pin operated with a hand or a finger to lock or unlock the door.

The controller 1 receives detection signals of various sensors such as a movable body sensor 6, a proximate object sensor 7, a vehicle speed sensor 8, and a buckle switch sensor 9. The movable body sensor 6 detects the approach of a movable body, such as another vehicle, from the rear or the like. The proximate object sensor 7 detects an obstacle in the proximity of the vehicle or door. The vehicle speed sensor 8 detects the traveling speed of the vehicle. The buckle switch sensor 9 detects fastening of a seat belt, that is, whether or not a tongue plate of the seat belt has been fixed to a seat belt buckle device. The CPU 2 of the controller 1 receives the detection signals of the sensors 6 to 9.

The controller 1 is connected to a door lock drive unit 10 directly or indirectly via an on-board bus. The CPU 2 controls the door lock drive unit 10 in accordance with a predetermined program to lock and unlock the door. The door lock drive unit 10 may include an electric motor.

The operation of the vehicle door lock device will now be described with reference to FIG. 2.

When the detection signals of the vehicle speed sensor 8 and the buckle switch sensor 9 indicate that the vehicle is traveling or the seat belt is fastened, the controller 1 keeps the door in a lock state with the door lock drive unit 10. When the detection signals of the vehicle speed sensor 8 and the buckle switch sensor 9 indicate that the vehicle is still and the seat belt has been unfastened, the controller 1 permits or executes unlocking of the door in accordance with the flowchart of FIG. 2.

The controller 1 detects whether there is a danger existing around the vehicle from the detection signals of the movable body sensor 6 and the proximate object sensor 7 (step S1). For example, when the movable body sensor 6 detects the approach of another movable body and/or when the proximate object sensor 7 detects the existence of an obstacle at a proximate position, the controller 1 determines that a danger exists around the vehicle.

When some kind of a danger exists, the controller 1 proceeds to step S2 and determines whether or not the occupant has touched the inside door handle 4 from the electrostatic capacitance of the electrostatic capacitance electrode 5. The controller 1 counts a number of times the occupant has touched the inside door handle 4 to get out of the vehicle (step S3).

The controller 1 determines whether the occupant has touched the inside door handle 4 for the first time or the second time (step S4). When it is the first time, the controller 1 keeps the door in a lock state with the door lock drive unit 10 (step S5) and then returns to step S1.

When the occupant touches the inside door handle 4 again to get out of the vehicle, the inside door handle 4 would have been touched for the second time in step S4 of the next routine subsequent to steps S1 to S3. Then, the controller 1 unlocks the door with the door lock drive unit (step S6) and resets a count value (step S7). Afterwards, the controller 1 temporarily ends the door lock control routine.

In step S1, when determining that there is no danger existing around the vehicle, the controller 1 proceeds to step S8 and determines whether or not the occupant has touched the inside door handle 4 to get out of the vehicle. When the occupant touches the inside door handle 4, regardless of the number of times the inside door handle 4 has been touched, the controller 1 unlocks the door with the door lock drive unit 10 (step S9) and temporarily ends the door lock control routine.

The controller 1 may include a single processor that functions as the CPU 2 and the electrostatic capacitance detection circuit 3. Alternatively, the controller 1 may include a plurality of processors or a plurality of auxiliary processors that function as the CPU 2 and the electrostatic capacitance detection circuit 3. For example, one or more (auxiliary) processors may include a first (auxiliary) processor and a second (auxiliary) processor. The first (auxiliary) processor counts the number of times the inside door handle 4 of the vehicle has been operated. The second (auxiliary) processor forcibly switches the door to an unlock state with the door lock drive unit 10 regardless of the detection signals of the sensors 6 to 9 when the count value of the number of times the inside door handle 4 of the vehicle has been operated, which was counted by the first (auxiliary) processor, is a predetermined value that is an integer greater than or equal to two.

The vehicle door lock device of the present embodiment has the advantages described below.

(1) When the occupant attempts to open the door in a state in which some kind of a danger exists around the vehicle, the door is kept in a lock state if the inside door handle 4 is operated for the first time to open the door. The maintained lock state notifies the occupant of the existence of a potential danger near the vehicle. Thus, the vehicle door lock device obviates dangers that would occur when opening the door without caution.

(2) Even in a state in which the controller 1 determines the existence of some kind of a potential danger near the vehicle from the detection signals of the movable body sensor 6 and the proximate object sensor 7, when the occupant operates the inside door handle 4 for the second time to open the door, the vehicle door lock device unlocks the door with the door lock drive unit 10. When operating the inside door handle 4 for the first time to open the door but the door does not open, the occupant will then check whether it is safe around the vehicle to get out of the vehicle, such as when the speed of the other vehicle is slow, and then operate the inside door handle 4 for the second time to open the door and quickly get out of the vehicle.

(3) If the controller 1 determines that no danger exists around the vehicle from the detection signals of the movable body sensor 6 and the proximate object sensor 7, the door can be unlocked with the door lock drive unit 10 when the occupant operates the inside door handle 4 for the first time to open the door. Thus, when there is no danger existing around the vehicle, the occupant can quickly get out of the vehicle.

The above embodiment may be modified as described below.

The sensors that detect whether or not a danger exists around the vehicle are not limited to the movable body sensor 6 and the proximate object sensor 7. In addition to or instead of the movable body sensor 6 and the proximate object sensor 7, any other sensor such as an on-board camera may be employed.

The controller 1 unlocks the door when the number of times the inside door handle has been operated by the occupant is equal to the predetermined value, which is an integer greater than or equal to two. The predetermined value is preferably two, which is the maximum value indicating a manual and successive operation, but may be three or greater.

The means for detecting whether or not the occupant has operated the inside door handle is preferably an electrostatic capacitance electrode handle sensor, which is the electrostatic capacitance electrode 5. Instead, a non-capacitance handle sensor may be used as long as a detection signal indicating operation of the inside door handle 4 can be provided to the controller 1.

The present disclosure encompasses the following implementations. Reference numbers are added below to aid understanding of the relationship of the embodiment and the implementations.

In several implementations, a count value of a number of times an inside door handle (4) has been operated is a count value of a number of times a manual action has been performed to move the inside door handle (4) and open the door from inside a vehicle, typically, a count value of a number of times the inside door handle (4) has been pulled.

A vehicle door lock device according to several implementations, the vehicle door lock device including:

an electric motor (10) that locks and unlocks a vehicle door; and

a controller (1) that controls the electric motor (10), wherein

the controller (1) includes

an inside door handle sensor (5) that detects a manual operation performed by an occupant on an inside door handle (4) of the vehicle door, and

one or more processors (2) that keep the vehicle door locked with the electric motor (10) when receiving a detection signal from one or more non-inside door handle sensors (6 to 9) that detect a condition of a vehicle other than the vehicle door and a condition outside the vehicle and determining from the detection signal that door opening cannot be safely performed, and

the one or more processors (2, 3) are configured to drive the electric motor (10) and forcibly switch the vehicle door to unlock regardless of the detection signal of the one or more non-inside door handle sensors (6 to 9) when the one or more processors (2, 3) detect from the inside door handle sensor (3) a manual and successive operation performed on the inside door handle (4).

It will be apparent to those skilled in the art that the present invention may be embodied in other specific forms without departing from the technical spirit thereof. For example, some of the components described in the embodiment (or one or more aspects thereof) may be omitted, or some of the components may be combined. The scope of the invention should be determined with reference to the appended claims along with the full scope of equivalents to which the appended claims are entitled.

### DESCRIPTION OF REFERENCE CHARACTERS

1) controller; 2) CPU; 3) electrostatic capacitance detection circuit; 4) inside door handle; 5) electrostatic capacitance electrode; 6) movable body sensor; 7) proximate object sensor; 8) vehicle speed sensor; 9) buckle switch sensor

1. A vehicle door lock device comprising:
one or more sensors configured to detect whether or not a door of a vehicle can be safely opened;
a door lock drive unit configured to switch the door between a lock state and an unlock state; and
a controller configured to receive a detection signal of the one or more sensors and control the door lock drive unit, wherein
the controller includes one or more processors,
the one or more processors are configured to keep the door in the lock state with the door lock drive unit when determining from the detection signal of the one or more sensors that the door cannot be safely opened,
the one or more processors are configured to count a number of times an inside door handle of the door has been operated, and the one or more processors are configured to forcibly switch the door to the
unlock state with the door lock drive unit regardless of the detection signal from the one or more sensors when a count value of the number of times the inside door handle has been operated is greater than or equal to a predetermined value that is an integer greater than or equal to two.

2. The vehicle door lock device according to claim 1, wherein
the controller includes an electrostatic capacitance detection circuit, wherein the electrostatic capacitance detection circuit is connected to an electrostatic capacitance electrode, electrostatic capacitance of which is configured to be increased when the inside door handle is operated, to detects electrostatic capacitance of the electrostatic capacitance electrode, and
the one or more processors is configured to obtain a number of times the electrostatic capacitance detected by the electrostatic capacitance detection circuit increases as the number of times the inside door handle has been operated.

3. The vehicle door lock device according to claim 1, wherein the one or more sensors include
a movable body sensor configured to detect a movable body approaching the vehicle, and
a proximate object sensor configured to detect an obstacle proximate to the vehicle.

4. The vehicle door lock device according to claim 1, wherein the one or more processors is configured to forcibly switch the door lock drive unit to the unlock state when the count value is two or greater.

5. The vehicle door lock device according to claim 3, wherein
the one or more sensors include a vehicle speed sensor and a buckle switch sensor, and
the one or more processors is configured to maintain a door lock state regardless of the count value when the vehicle is traveling, which is detected by the vehicle speed sensor, and when a seat belt is fastened, which is detected by the buckle switch sensor.
